(19) United States
(12) Patent Application Publication
(10) Pub. No.: US 2003/0021626 A1
(43) Pub. Date: Jan. 30, 2003

(54) Fault-preventive folding slide sleeve structure for stroller

(76) Inventor: Hung-Chung Hou, Chia-I Hsien (TW)

Correspondence Address: BIRCH STEWART KOLASCH & BIRCH, PO BOX 747, FALLS CHURCH, VA, 22040-0747, US

(21) Appl. No.: 09/910,717

(22) Filed: Jul. 24, 2001

(51) Int. Cl. F16D 1/00; B25G 3/18; F16B 21/00

(52) U.S. Cl. 403/322.4

(57) ABSTRACT

A fault-preventive folding slide structure for a stroller includes a slide sleeve and a release button. The slide sleeve can reciprocally slide on a handle bracket of the stroller and has a finger opening located on one side to allow a user to move the slide sleeve with a finger and pull a leash wire to control a folding joint of the stroller. The slide sleeve also has a free end engageable with a notch formed on the handle bracket to prevent the user from inadvertently triggering the folding joint. The user may use the forefinger or other finger to engage with the finger opening and push the release button with the thumb to move the free end away from the notch for pulling the leash wire to trigger the folding joint.

### FIELD OF THE INVENTION

The invention relates to a joint control mechanism for folding strollers and particularly a fault-preventive folding slide sleeve structure for preventing a stroller frame from inadvertently collapsing and folding.

### BACKGROUND OF THE INVENTION

Folding infant or child strollers are very popular these days. They generally have a leash wire made of rope or cable to trigger a folding joint to control a folding mechanism built therein. While it is generally handy to collapse and fold the strollers, their safety during use has become a growing concern. The need is seen to build a foolproof function in the control of the release mechanism to prevent the strollers from inadvertently collapsing, so that the infant or child sitting in the stroller will be better protected and not be frightened g or even fall out of the stroller and get hurt.

U.S. Pat. No. 6,068,284 to Baku Kakuda discloses a “Stroller with one hand release mechanism and one hand release mechanism thereof,” which allows a user to collapse the folding stroller with only one hand. It has a release mechanism mounted on the handle of the stroller to transform a rotation to a linear motion to move a wire for triggering a folding joint. A latch member is provided to anchor the mechanism when not being triggered. The latch member may be moved to turn the release mechanism for collapsing the stroller when desired. Kakuda's design uses the latch member to prevent a user from inadvertently collapsing the stroller. However, this design is suitable for only U-shaped stroller handles, thus has limited applicability.

While the release design for singlehanded operation is convenient to use, not all consumers appreciate or accept its application limitations. The invention aims to offer a fault-preventive stroller folding mechanism to meet the requirements of those consumers who are not totally satisfied with the strollers utilizing a singlehanded collapsing method or with a U-shaped handle.

### SUMMARY OF THE INVENTION

The primary object of the invention is to provide an additional choice to satisfy the requirements of consumers to collapse a folding stroller safely and easily. The invention offers a slide sleeve on the handle bracket of the stroller to pull a leash wire fastened to the folding joint of the stroller. There is a release button which has a free end engageable with a notch on the handle bracket to prevent the stroller from inadvertently collapsing. The slide sleeve also has a finger aperture to allow the user's forefinger or other fingers to anchor the slide sleeve while using the thumb to push the release button to disengage the free end of the slide sleeve from the notch, so that the leash wire may be pulled to activate the folding mechanism in the joint.

The foregoing, as well as additional objects, features and advantages of the invention will be more readily apparent from the following detailed description, which proceeds with reference to the accompanying drawings. The drawings are only for reference and illustrative purposes, and thus are not intended to limit the scope of the invention.

### BRIEF DESCRIPTION OF THE DRAWINGS

FIG. 1 is a schematic view of the invention mounted to a stroller frame.

FIG. 2 is a perspective view of a first embodiment of the invention.

FIG. 3 is a sectional view of the first embodiment at one operation state.

FIG. 4 is a sectional view of the first embodiment at another operation state.

FIG. 5 is a side view of a second embodiment of the invention.

### DESCRIPTION OF THE PREFERRED EMBODIMENTS

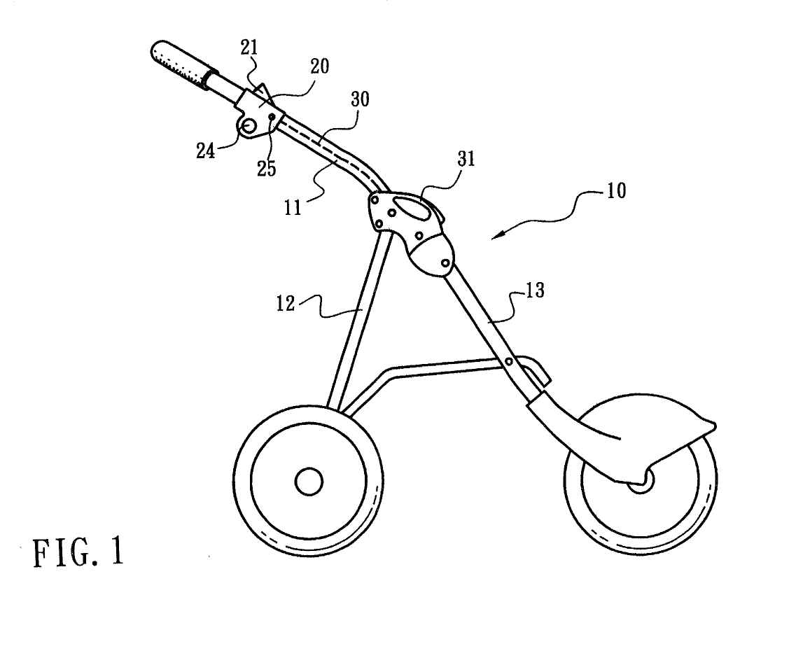

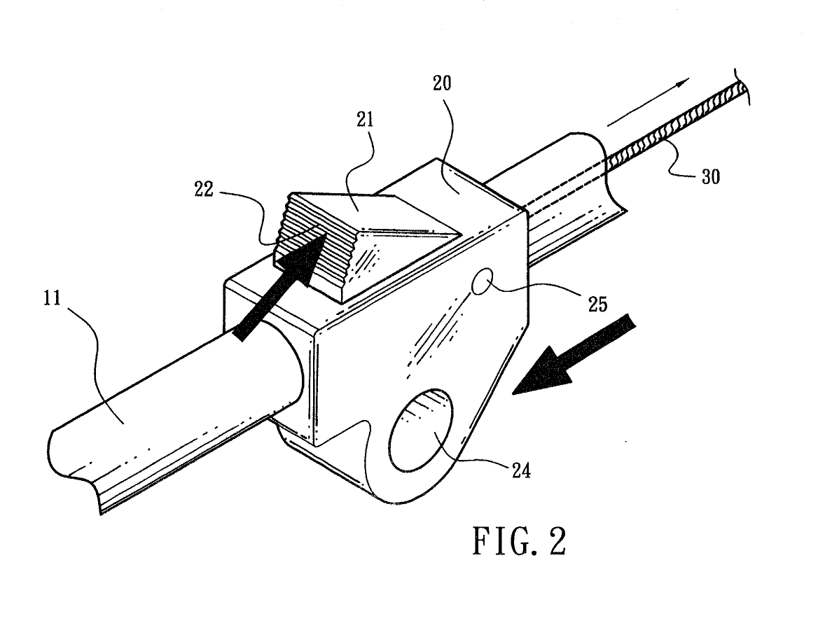

Referring to FIGS. 1 and 2, a folding stroller frame 10 includes a front wheel bracket 13, a rear wheel bracket 12 and a handle bracket 11. The handle bracket 11 has an elongated slot 1101 and an indented notch 1102, and is coupled with a slide sleeve 20 from the outside. The slide sleeve 20 is reciprocally movable on the handle bracket to pull a leash wire 30 for triggering a handle joint 31 to control the collapsing and folding of the stroller.

Referring to FIGS. 2, 3 and 4, the slide sleeve structure of the invention includes a slide sleeve 20 and a release button 21. The slide sleeve 20 is mounted on the handle bracket 11 and has a transverse element 25 running through it to engage with an elongated slot 1101 formed on the handle bracket 11. Hence, the slide sleeve 21 is reciprocally movable on the handle bracket 11 within a displacement between the two ends of the slot 1101. One side of the slide sleeve 20 has a finger aperture 24 to engage with a finger of the user. The transverse element 25 may be a rivet or pin for running through the slot 1101 and fastening to the leash wire 30.

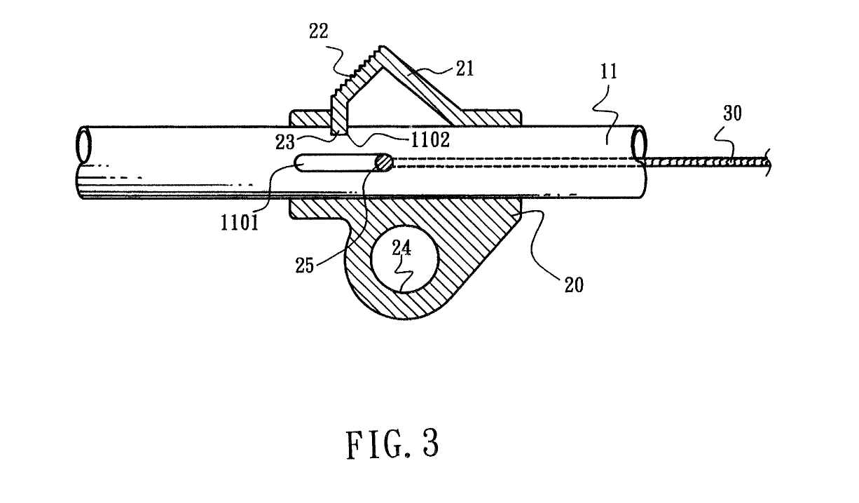

Referring to FIG. 3, the leash wire 30 runs through the interior of the handle bracket 11 and engages with the joint 31. The joint 31 is harnessed by a spring (not shown in the drawing) to produce tension on the slide sleeve 20. The tension keeps the slide sleeve 20 located at a lower end of the displacement. At this position, the free end 23 of the slide sleeve 20 is engaged with the notch 1102 formed on the handle bracket so that the slide sleeve 20 will be prevented from moving if the user inadvertently hits the slide sleeve 20.

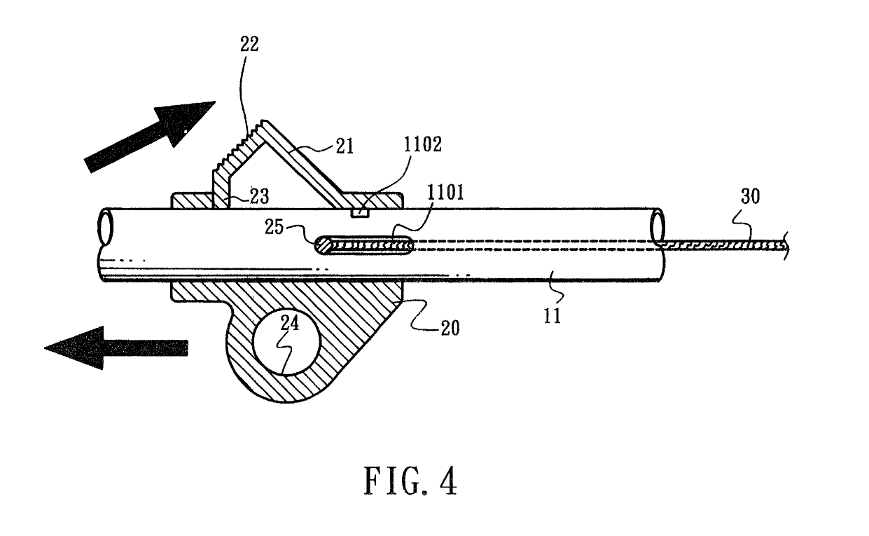

Referring to FIG. 4, when activating the collapsing and folding mechanism of the joint 31, the user must move the free end 23 of the release button 21 away from the notch 1102, then pull the slide sleeve 20 to withdraw the leash wire 30. By means of the construction set forth above, the stroller may be prevented from incidentally collapsing due to the user's inadvertent actions, and may provide better protection for the infant or child sitting in the stroller.

According to the embodiments of the invention, the release button 21 is extended from and exposed on the exterior of the slide sleeve 20. The release button 21 has at least a free end 23 to engage with the notch 1102 on the handle bracket 11 for restricting the sliding of the slide sleeve 20. The leash wire 30 has one end fastened to the slide sleeve 20 and the other end fastened to the joint 31. When the slide sleeve 20 slides, the leash wire 30 pulls the joint 31 to activate the collapsing and folding mechanism. The release button 21 and slide sleeve 20 are preferably integrally formed together to save assembly costs. The material for integral forming has elastic properties to allow the free end 23 to easily and securely engage with the notch 1102 to keep the slide sleeve 20 at a constant desired position to prevent the slide sleeve from sliding. The notch 1102 may be a recess pit, a cavity, a groove, a through opening or the like. Furthermore, the notch 1102 may also be substituted by other means of equivalent effect, such as a transverse rib or bulged spots (not shown in the drawings) formed on the handle bracket 11, as long as it can engage with the free end 23. There are many other alternatives known in the art that may provide an equivalent effect of automatically preventing the slide sleeve 20 from sliding, and these may be incorporated in the embodiments of the invention.

Referring to FIGS. 3 and 4, when pulling the slide sleeve 20 the user must push the release button 21 to raise the free end 23. In order to facilitate the operation and to avoid finger slippage, the outer surface of the release button 21 may be formed with an embossed surface 22 of rough textures or transverse patterns or the like.

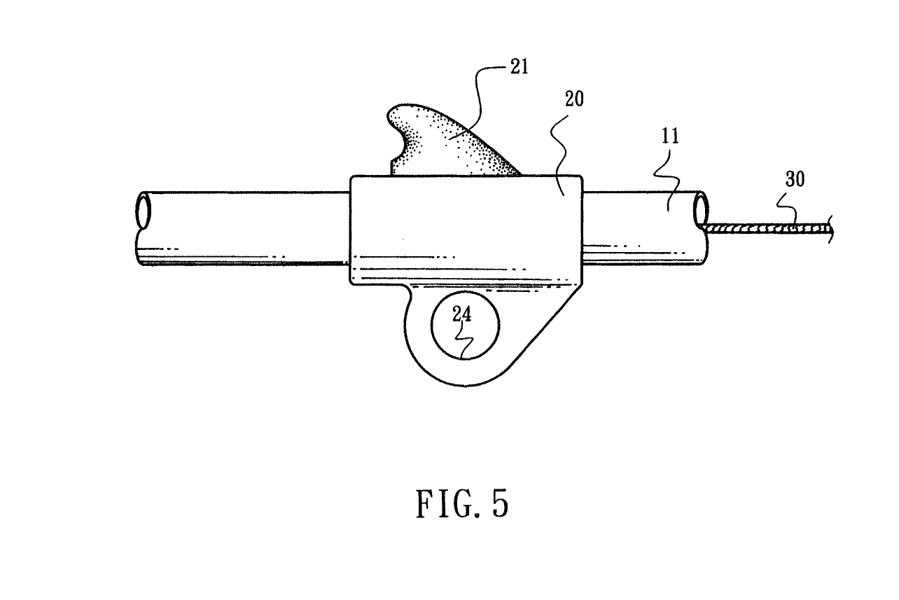

Referring to FIG. 5, the release button 21 may also have a selected exterior contour to substitute the embossed surface 22 to facilitate operation without slipping. In addition, the release button 21 may also be coated with a layer of high friction coefficient material to prevent slipping.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

What is claimed is:

1. A fault-preventive folding slide sleeve structure for coupling with a stroller frame which has an elongated slot and a notch and a joint located at a lower end controlled by a leash wire, the slide sleeve structure comprising:
a slide sleeve having a through opening to couple with the frame and a transverse element engageable with the elongated slot and being movable reciprocally within a displacement defined by two ends of the elongated slot;
a release button bonded to the slide sleeve and extended outwards from the slide sleeve having a free end engageable with the notch for restricting the slide movement of the slide sleeve; and
a leash wire having one end fastened to the slide sleeve and other end fastened to the joint controlled by the leash wire to allow the slide sleeve to pull the joint by the leash wire when sliding.

2. The fault-preventive folding slide sleeve structure of claim 1, wherein the slide sleeve has a finger opening located at one side thereof to engage with an user's finger for moving the slide sleeve.

3. The fault-preventive folding slide sleeve structure of claim 1, wherein the release button has an embossed surface to prevent user's finger from slipping during contact thereof.

4. The fault-preventive folding slide sleeve structure of claim 3, wherein the embossed surface is selectively formed by embossed spots or embossed textures.

5. The fault-preventive folding slide sleeve structure of claim 1, wherein the release button has anti-slipping surface made of material of high friction coefficient to prevent user's finger from slipping during contact thereof.

6. The fault-preventive folding slide sleeve structure of claim 1, wherein the release button and the slide sleeve are integrally formed from a material which has elastic property to facilitate the coupling between the free end and the notch.

7. The fault-preventive folding slide sleeve structure of claim 1, wherein the leash wire runs through the interior of the stroller frame to fasten to the transverse element of the slide sleeve.

8. The fault-preventive folding slide sleeve structure of claim 1, wherein the joint is harnessed by a spring to keep the leash wire under tension constantly.

9. The fault-preventive folding slide sleeve structure of claim 8, wherein the spring forces the leash wire to let the slide sleeve stay or slide to the position where the free end wedging in the notch to prevent the slide sleeve from sliding.

10. The fault-preventive folding slide sleeve structure of claim 1, wherein the notch of the frame is selectively a recess pit, a cavity or a groove.

11. The fault-preventive folding slide sleeve structure of claim 1, wherein the transverse element is a rivet or a pin.

12. A fault-preventive folding slide sleeve structure for coupling with a stroller frame which has at least a front wheel bracket, a rear wheel bracket, a handle bracket and a joint controlled by a leash wire, the handle bracket having an elongated slot and a notch to couple with the slide sleeve structure, comprising:
a slide sleeve having a through opening to couple with the handle bracket and a transverse element engageable with the elongated slot and being movable reciprocally within a displacement defined by two ends of the elongated slot;
a release button bonded to the slide sleeve and extended outwards from the slide sleeve having a free end engageable with the notch for restricting the slide movement of the slide sleeve; and
a leash wire having one end fastened to the slide sleeve and other end fastened to the joint controlled by the leash wire to allow the slide sleeve to pull the joint by the leash wire when sliding.

13. The fault-preventive folding slide sleeve structure of claim 12, wherein the slide sleeve has a finger opening located at one side thereof to engage with an user's finger for moving the slide sleeve.

14. The fault-preventive folding slide sleeve structure of claim 12, wherein the release button has an embossed surface to prevent user's finger from slipping during contact thereof.

15. The fault-preventive folding slide sleeve structure of claim 14, wherein the embossed surface is selectively formed by embossed spots or embossed textures.

16. The fault-preventive folding slide sleeve structure of claim 12, wherein the release button has anti-slipping surface made of material of high friction coefficient to prevent user's finger from slipping during contact thereof.

17. The fault-preventive folding slide sleeve structure of claim 12, wherein the release button and the slide sleeve are integrally formed from a material which has elastic property to facilitate the coupling between the free end and the notch.

18. The fault-preventive folding slide sleeve structure of claim 12, wherein the leash wire runs through the interior of the stroller frame to fasten to the transverse element of the slide sleeve.

19. The fault-preventive folding slide sleeve structure of claim 12, wherein the joint is harnessed by a spring to keep the leash wire under tension constantly.

20. The fault-preventive folding slide sleeve structure of claim 19, wherein the spring forces the leash wire to let the slide sleeve stay or slide to the position where the free end wedging in the notch to prevent the slide sleeve from sliding.

21. The fault-preventive folding slide sleeve structure of claim 12, wherein the notch of the frame is selectively a recess pit, a cavity or a groove.

22. The fault-preventive folding slide sleeve structure of claim 12, wherein the transverse element is a rivet or a pin.
